(19) United States
(12) Patent Application Publication
(10) Pub. No.: US 2024/0283048 A1
(43) Pub. Date: Aug. 22, 2024

(54) Cooling system of Battery Pack and its manufacturing method

(71) Applicant: ArcelorMittal, Luxembourg (LU)

(72) Inventors: Astrid GREGOIRE, Amneville (FR); Christian ALLELY, Metz (FR); Tiago MACHADO AMORIM, Longeville les Metz (FR); Matthieu AMBLARD, Senlis (FR)

(21) Appl. No.: 18/292,722

(22) PCT Filed: Jun. 21, 2022
(86) PCT No.: PCT/IB2022/055738

§ 371 Date: Jan. 26, 2024

(30) Foreign Application Priority Data
Aug. 2, 2021 (WO) PCT/IB2021/057033

(51) Int. Cl. H01M 10/655; C23C 2/12; C23C 2/40; H01M 10/613; H01M 10/6567

(52) U.S. Cl. CPC H01M 10/655; C23C 2/12; C23C 2/40; H01M 10/613; H01M 10/6567

(57) ABSTRACT

A cooling system of a battery pack including a metallic coated steel sheet wherein the metallic coating includes aluminium, zinc, optionally silicon and unavoidable impurities coming from the production process.

The present invention deals with batteries that can notably be used in the car industry, and more specifically relates to material for a cooling system of a battery pack in an electric or hybrid vehicle having good resistance corrosion in contact with liquid coolants.

### BACKGROUND

Electrical vehicles or hybrid vehicles must embed at least one heavy and bulky battery pack for powering their engine. This battery pack is made of a plurality of battery modules, each module containing battery cells. Cells are designed to store, retain and deliver on demand the electrical potential difference between their both electrodes. However, the functional abilities of cells are dependent on their working temperature, as the movement of the charged particles through the electrolytes also depends on temperature.

For this reason, battery packs are designed for a specific temperature working range. The usual working range is 20 to 40° C. They also have to keep the temperature difference within the battery pack to a minimum (usually no more than 5° C.). Their performance would decrease, and they would stop operating if there were no cooling system to keep them in their working range. Furthermore, thermal stability issues, such as thermal runaway, and fire explosion, could occur if the battery overheats or if there is a non-uniform temperature distribution in the battery pack. In view of life-threatening safety issues and environmental issues related to the lifetime of battery packs, the cooling system is of major importance.

Air-cooling by convection was the technical solution on the first generation of electrical vehicles. However, with electric cars being used more frequently with higher energy requiring less frequent charges, safety issues have arisen with purely air-cooled battery packs. Liquid cooling systems are thus now commonly implemented into electric vehicles.

### SUMMARY OF THE INVENTION

As depicted on FIG. 1, a possible design of a battery pack may comprise the following parts from the bottom to the top:
a lower shield element 1;
lower cross members 2;
a liquid cooling system 3;
an outer frame 4;
a tray to retain possible runouts from battery cells 5;
an inner frame 6;
upper cross members 7;
an optional additional liquid cooling system 8;
a top cover 9.

The structure of the cooling system is dependent on the shape of the battery pack and will look different for each car manufacturer. Depending on the design of the cooling system, it can be directly attached underneath the tray (5), and in contact with it to exchange heat towards the battery cells. Alternatively, it can be included in the battery pack by laying into the tray (5).

Liquid cooling systems consist of heat exchangers with pipes through which a liquid coolant circulates. Compatibility of coolant and exchanger surfaces is critical to the durability of the cooling system.

Liquid coolants usually comprise more than 90% of glycol, polyglycol like ethylene glycol, propylene glycol or the same. It has been chosen as the major component because it raises temperature of the boiling point and lowers the temperature of the freezing point. The remainder are additives, surface inhibitors to prevent corrosion, cavitation and deposit. It may also include a pH buffer, a defoamer, a stabilizer and a bittering agent.

Corrosion inhibitors are designed to prevent corrosion occurring in the numerous dissimilar metals found along the circuit of a cooling system in a battery pack. The composition of liquid coolants varies from a supplier to another, and each automotive manufacturer recommends one which suits to their specific design of cooling system.

An aim of the present invention is to provide a cooling system that has outstanding corrosion resistance, whatever the additives in the liquid coolant.

The present invention provides a cooling system for battery pack comprising a metallic coated steel sheet, wherein said metallic coating comprises aluminium, zinc, optionally silicon and unavoidable impurities. Another object of the invention is a battery pack including a cooling system according to the invention.

### BRIEF DESCRIPTION OF THE DRAWINGS

Other characteristics and advantages of the invention will become apparent from the following detailed description of the invention.

To illustrate the invention, various embodiments and trials of non-limiting examples will be described, particularly with reference to the following figures:

FIG. 1 illustrates a battery pack,

FIG. 2 illustrates the dimension and design of a sample used in the examples to assess the compatibility of the coolant with the metallic coatings considered,

FIG. 3 illustrates the sample holder used in the examples to assess the compatibility of the coolant with the metallic coatings considered,

FIG. 4 illustrates of possible design of the cooling system

FIG. 5 is a partial cross-section of the same possible design of the cooling system.

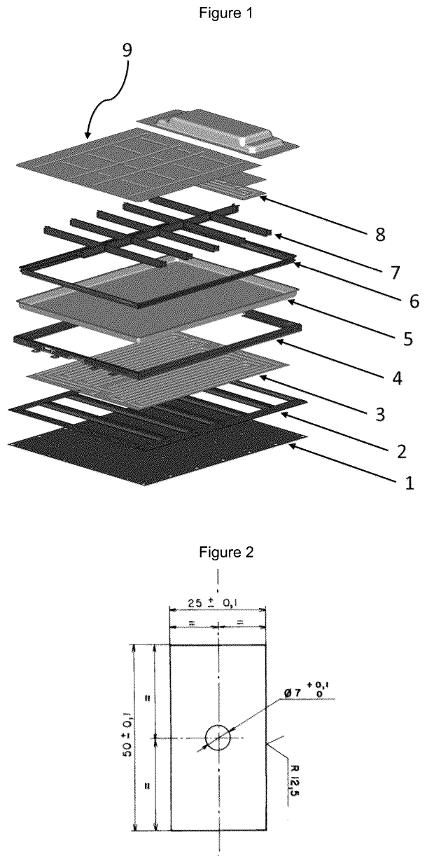

### DETAILED DESCRIPTION

The invention relates to a cooling system of battery pack comprising a metallic coated steel sheet wherein said metallic coating comprises aluminium, zinc, optionally silicon and unavoidable impurities coming from the production process.

For this purpose, any steel can be used in the frame of the invention. Preferably, steels having a good formability are well suited. For example, the cooling system can be made of mild steel for deep drawing such as Interstitial Free steel having the following weight composition: C≤0.01%; Si≤0.3%; Mn≤1.0%; P≤0.1%; S≤0.025; Al≥0.01%; Ti≤0.12%; Nb≤0.08%; Cu≤0.2%.

For example, the cooling system can be made of High Strength Low Alloy (HSLA) steel having the following weight composition: C≤0.1%; Si≤0.5%; Mn≤1.4%; P≤0.04%; S≤0.025%; Al≤0.01%; Ti≤0.15%; Nb≤0.09%; Cu≤0.2%.

The steel sheet can be obtained by hot rolling of a steel slab and subsequent cold rolling of the obtained steel coil, depending on the desired thickness, which can be for example from 0.6 to 1.0 mm.

The steel sheet is then coated with a metallic coating by any coating process. For examples, the steel sheet is hot-dip coated in a molten bath comprising aluminium, zinc, optionally silicon and unavoidable impurities.

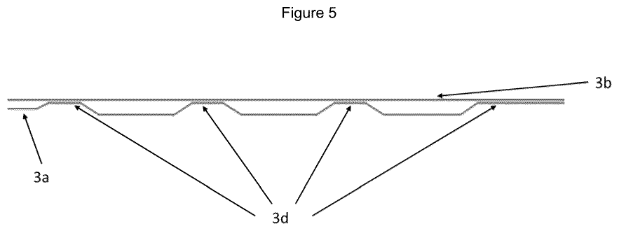

The steel sheet can then be cut into a blank. In a preferred embodiment, the cooling system is made of two sheets, one sheet being shaped. As depicted on FIG. 4, the lower sheet (3a) is formed to let the coolant liquid flow through the stamped ducts (3c). The forming of the sheet can occur by press stamping. The lower sheet (3a) is covered by an upper sheet (3b), both being then in contact with the liquid coolant. As shown on the partial cross-section of FIG. 5, the upper sheet (3b) closes the stamped ducts of the lower sheet (3a). The two sheets have contact lines (3d). For tightness of the coolant liquid circuit, both sheets can be welded to each other by resistance seam welding along the contact lines.

The metallic coating used in the invention comprises aluminium, zinc, optionally silicon and unavoidable impurities coming from the production process.

In a preferred embodiment, the coating comprises from 35 to 49% by weight of zinc, from 0.5 to 3% by weight of silicon, and optionally up to 4% by weight of iron, the balance being aluminum and unavoidable impurities.

For example, the coating is AluZinc with the following weight composition: 43.4% of zinc, 1.6% of silicon, the balance being aluminium.

The coating weight can be of 50 to 200 g/m² in total on both sides or less. For example, the coating thickness on the side in contact with the liquid coolant is 10 to 40 μm.

The inventors have conducted several tests showing the performance of this coating with different liquid coolants. Surprisingly, such a coating as a good behavior with all tested coolants, which is not the case of other coatings with different compositions.

### EXAMPLES

To assess the compatibility of the coolant and the metallic coatings considered, a test was performed basing on the French standard NF R15-602 issued in 1991. It specifies a laboratory test method for evaluating the corrosion inhibiting properties of a coolant for metals typical of those present in automotive cooling systems. The corrosion inhibiting properties of coolants are measured by a glassware corrosion method. The corrosion inhibiting properties of coolants are measured by a glassware corrosion method. At the end of the test, samples are measured in terms of mass gain and mass loss after chemical cleaning. For both gain and loss, the mass difference after the test must not be above 2.5 mg/sample according to the standard.

The test was performed with two usual coolants from the supplier company MOTUL, covering most of the electrical vehicle manufacturers.

Three materials were tested in combination with these liquids, the commercial name of which are gathered in table 1. The three materials tested were cut from are hot-dip coated steel sheets.

Material 1 is coated with Extragal® GI. The hot-dip coating contains 0,2% of aluminium by weight, the remainder being zinc. The coating weight is 140 g/m².

Material 2 is coated with Galfan. The hot-dip coating contains 5% by weight of aluminium, the remainder being zinc. The coating weight is 200 g/m².

Material 3 is coated with AluZinc. The hot-dip coating contains by weight 43,4% of zinc, 1,6% of silicon, the remainder being aluminium. The coating weight is 150 g/m².

TABLE 1
Coolant liquids

| Coolant Liquid No | CL 2 | CL 3 |
|---|---|---|
| Motul Commercial Name | S110 | Type D |

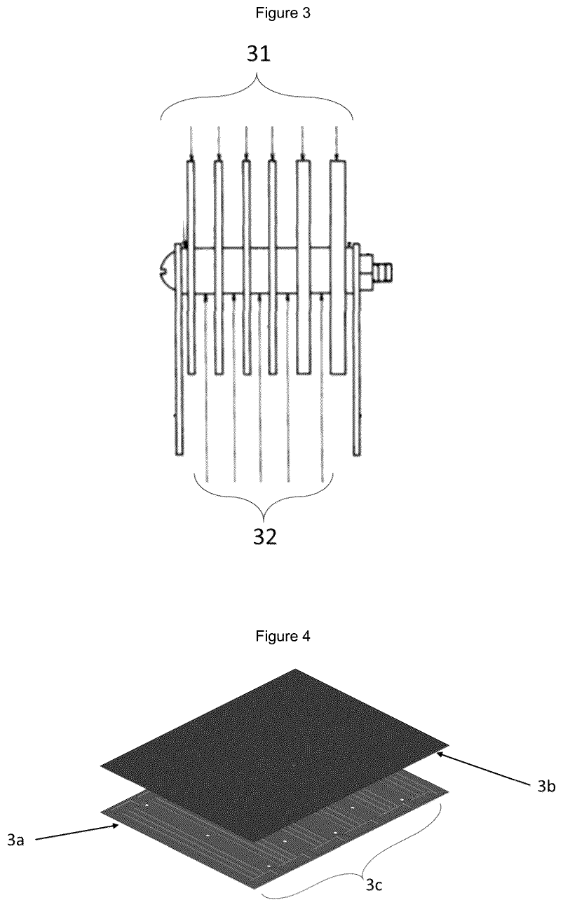

Steel sheets were cut into 5×2.5 cm samples, with central hole as depicted on FIG. 2. Then the samples were mounted by set of 6 on a sample holder, each coupon being in contact only with polytetrafluoroethylene (PTFE) to avoid any galvanic coupling, as depicted on FIG. 3. Indeed, the 6 samples (31) are separated by 5 PTFE spacers (32), and all the other holding devices are either made of PTFE or isolated brass. Then the sample holder is put into a coolant reactor having a volume of 750 ml. The coolant is then diluted at 33% in terms of volume fraction into a synthetic corrosive water containing 148 mg/mol of Na₂SO₄, 165 mg/l of NaCl and 138 mg/l of NaHCO₃. The resulting solution is heated at 100° C. to fill the coolant reactor, while air bubbling through the coolant is set at a flow of 100 ml/min. After 14 days, the samples are removed from the reactor and characterized in terms of mass gain, mass loss. Mass gain is obtained by weighting the samples out of the reactor.

Mass loss is obtained by weighting the samples after chemical cleaning of the corrosion products. To this purpose, the ISO 8407 Standard issued in 2009 was applied. The removal method depends on the considered material. For materials 1 and 2 based on zinc, the chemical cleaning procedure C.9.1 was applied by immersion of the corrosion test specimen in a chemical solution of glycine. For material 3 comprising aluminium and zinc, the chemical cleaning procedure C.9.3 was applied by immersion of the corrosion test specimen in a chemical solution of chromium acid.

TABLE 2
Results with coolant liquid 2 (S110)

| Coolant | Material | Mass gain (mg/sample) | Mass loss (mg/sample) |
|---|---|---|---|
| S110 | 1 | 35 | 1.1 |
| | 2 | 51 | 0.3 |
| | 3* | 1.2 | 1.1 |

*according to the invention

TABLE 3
Results with coolant liquid 3 (Type D)

| Coolant | Material | Mass gain (mg/sample) | Mass loss (mg/sample) |
|---|---|---|---|
| Type D | 2 | 3.6 | +2.5 |
| | 3* | 1.1 | 1.7 |

*according to the invention

Materials 1 and 2 have mass gain or mass loss of more than 2.5 mg/sample for at least one liquid coolant. Only material 3 has mass gain and mass loss less than 2.5 mg/sample for each coolant.

1-5. (canceled)

6: A cooling system for battery pack comprising:
a metallic coated steel sheet having a steel sheet with a metallic coating, the metallic coating including aluminium, zinc, optionally silicon and unavoidable impurities.

7: The cooling system as recited in claim 6 wherein the metallic coating comprises by weight from 35 to 49% by weight of zinc, from 0.5 to 3% by weight of silicon, and optionally up to 4% by weight of iron, a balance being aluminum and unavoidable impurities.

8: The cooling system as recited in claim 6 wherein the metallic coating has a coating thickness of 10 to 40 μm on a side in contact with the liquid coolant.

9: The cooling system as recited in claim 6 wherein the metallic coated steel sheet has a coating weight of 50 to 200 g/m² in total on both sides.

10: A battery pack comprising the cooling system as recited in claim 6.
